(19) United States
(12) Patent Application Publication
(10) Pub. No.: US 2024/0404811 A1
(43) Pub. Date: Dec. 5, 2024

(54) METHODS AND SYSTEMS FOR PROCESSING IN REAL-TIME AND USING GAUSSIAN

(71) Applicant: DH TECHNOLOGIES DEVELOPMENT PTE. LTD., Singapore (SG)

(72) Inventors: Calin Bradau, Concord (CA); Thomas Binko, Concord (CA); Nicolae Albeanu, Concord (CA)

(21) Appl. No.: 18/698,102

(22) PCT Filed: Oct. 3, 2022
(86) PCT No.: PCT/IB2022/059434

§ 371 Date: Apr. 3, 2024

Related U.S. Application Data
(60) Provisional application No. 63/252,306, filed on Oct. 5, 2021.

(51) Int. Cl. H01J 49/00; H01J 49/02; H01J 49/40

(52) U.S. Cl. CPC H01J 49/0036; H01J 49/022; H01J 49/40

(57) ABSTRACT

Systems and methods are provided for processing in real-time and using Gaussian fitting digitized signals from ions detection in time-of-flight (TOP) mass spectrometry. Acquisition/analog-to-digital conversion may be applied in the course of Ion detection during time-of-flight (TOP) mass spectrometry, with the acquisition/analog-to-digital conversion including generating, in response to detection of ions, one or more time-of-flight (TOP) based signals, and digitizing, using analog-to-digital conversion, the one or more TOP based signals, to generate corresponding digitized data. The digitized data may then be processed, in real-time and based on use of Gaussian fitting, to generate result data corresponding to the time-of-flight (TOP) mass spectrometry. The Gaussian fitting may comprise applying second (2nd) degree polynomial fit, such as by least squares via QR factorization.

### RELATED APPLICATIONS

The present patent application claims the priority benefit of U.S. Provisional Patent Application Ser. No. 63/252,306, filed Oct. 5, 2021, the content of which is hereby incorporated by reference in its entirety into this disclosure.

### BACKGROUND

Conventional approaches, if any existed, for processing signals generated based on ions detection in time-of-flight (TOF) mass spectrometry may be costly, cumbersome, and/or inefficient—e.g., they may be complex and/or difficult to implement, may be slow, may yield imprecise and/or unreliable results, etc.

Limitations and disadvantages of conventional methods and systems will become apparent to one of skill in the art, through comparison of such approaches with some aspects of the present methods and systems set forth in the remainder of this disclosure with reference to the drawings.

### BRIEF SUMMARY

A system and/or method for processing in real-time and using Gaussian fitting digitized signals from ions detection in time-of-flight (TOF) mass spectrometry, substantially as shown in and/or described in connection with at least one of the figures, as set forth completely in the claims. These and other advantages, aspects and novel features of the present disclosure, as well as details of an illustrated embodiment thereof, will be more fully understood from the following description and drawings.

### BRIEF DESCRIPTION OF THE DRAWINGS

FIG. 1 illustrates a high-level block diagram of an example sample-processing system, upon which embodiments of the present disclosure may be implemented.

FIG. 2 illustrates a high-level block diagram of an example computer system, upon which embodiments of the present disclosure may be implemented.

FIG. 3 illustrates a high-level block diagram of an example data acquisition and conversion system, in accordance with an example embodiment of the present disclosure.

FIG. 4A-4D illustrate plots of example event amplitude and position measurements precision and accuracy over analog-to-digital convertor (ADC) full scale (FS), in accordance with an example embodiment of the present disclosure.

FIGS. 5A-5B illustrate plots of example tests for measurements stability, in accordance with an example embodiment of the present disclosure.

FIGS. 6A-6B illustrate plots of example of deconvolution of events spaced at full width at half max (FWHM) distance, in accordance with an example embodiment of the present disclosure.

FIG. 7A-7B illustrate plots of example of deconvolution of events spaced at full width at half max (FWHM) distance, in accordance with an example embodiment of the present disclosure.

FIG. 8 illustrates a plot of example results of estimated intensity of captured event with amplitude exceeding the analog-to-digital convertor (ADC) full scale (FS), in accordance with an example embodiment of the present disclosure.

FIG. 9A illustrates a plot of example events amplitude measurement precision for events exceeding the analog-to-digital convertor (ADC) full scale (FS), in accordance with an example embodiment of the present disclosure.

FIG. 9B illustrates a plot of example events amplitude measurement accuracy for events exceeding the analog-to-digital convertor (ADC) full scale (FS), in accordance with an example embodiment of the present disclosure.

FIG. 10A illustrates a plot of event position measurement precision as function of analog-to-digital convertor (ADC) full scale (FS), in accordance with an example embodiment of the present disclosure.

FIG. 10B illustrates a plot of event position measurement accuracy as function of analog-to-digital convertor (ADC) full scale (FS), in accordance with an example embodiment of the present disclosure.

### DETAILED DESCRIPTION

As utilized herein the terms “circuits” and “circuitry” refer to physical electronic components (e.g., hardware), and any software and/or firmware (“code”) that may configure the hardware, be executed by the hardware, and or otherwise be associated with the hardware. As used herein, for example, a particular processor and memory (e.g., a volatile or non-volatile memory device, a general computer-readable medium, etc.) may comprise a first “circuit” when executing a first one or more lines of code and may comprise a second “circuit” when executing a second one or more lines of code. Additionally, a circuit may comprise analog and/or digital circuitry. Such circuitry, for example, may operate on analog and/or digital signals. It should be understood that a circuit may be in a single device or chip, on a single motherboard, in a single chassis, in a plurality of enclosures at a single geographical location, in a plurality of enclosures distributed over a plurality of geographical locations, etc. Similarly, the term “module”, for example, may refer to a physical electronic components (e.g., hardware) and any software and/or firmware (“code”) that may configure the hardware, be executed by the hardware, and or otherwise be associated with the hardware.

As utilized herein, circuitry or module is “operable” to perform a function whenever the circuitry or module comprises the necessary hardware and code (if any is necessary) to perform the function, regardless of whether performance of the function is disabled or not enabled (e.g., by a user-configurable setting, factory trim, etc.).

As utilized herein, “and/or” means any one or more of the items in the list joined by “and/or”. As an example, “x and/or y” means any element of the three-element set {(x), (y), (x, y)}. In other words, “x and/or y” means “one or both of x and y.” As another example, “x, y, and/or z” means any element of the seven-element set {(x), (y), (z), (x, y), (x, z), (y, z), (x, y, z)}. In other words, “x, y and/or z” means “one or more of x, y, and z.”

As utilized herein, the term “exemplary” means serving as a non-limiting example, instance, or illustration. Further, as utilized herein, the terms “for example” and “e.g.,” set off lists of one or more non-limiting examples, instances, or illustrations.

The terminology used herein is for the purpose of describing particular examples only and is not intended to be limiting of the disclosure. As used herein, the singular forms are intended to include the plural forms as well, unless the context clearly indicates otherwise. It will be further understood that the terms “comprises,” “includes,” “comprising,” “including,” “has,” “have,” “having,” and the like when used in this specification, specify the presence of stated features, integers, steps, operations, elements, and/or components, but do not preclude the presence or addition of one or more other features, integers, steps, operations, elements, components, and/or groups thereof.

It will be understood that, although the terms first, second, etc. may be used herein to describe various elements, these elements should not be limited by these terms. These terms are only used to distinguish one element from another element. Thus, for example, a first element, a first component or a first section discussed below could be termed a second element, a second component or a second section without departing from the teachings of the present disclosure. Similarly, various spatial terms, such as “upper,” “lower,” “side,” and the like, may be used in distinguishing one element from another element in a relative manner. It should be understood, however, that components may be oriented in different manners, for example a semiconductor device may be turned sideways so that its “top” surface is facing horizontally and its “side” surface is facing vertically, without departing from the teachings of the present disclosure.

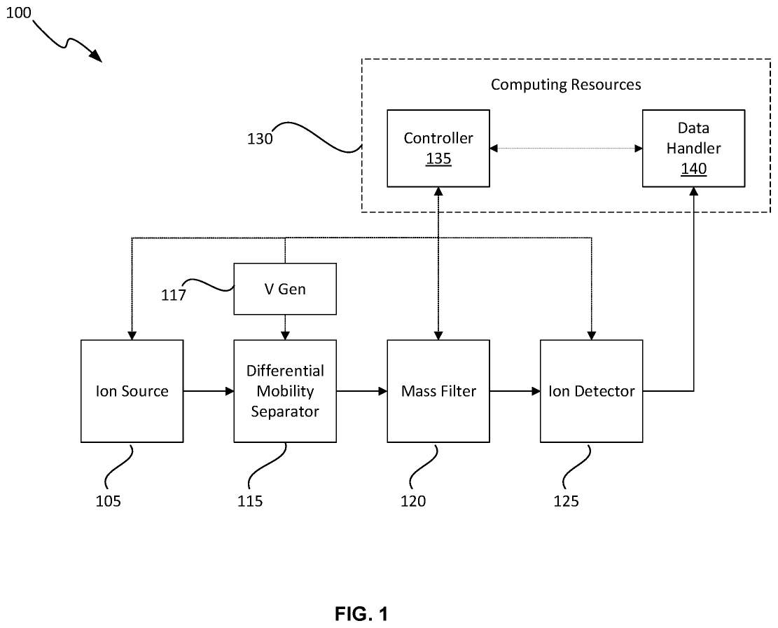

FIG. 1 illustrates a high-level block diagram of an example sample-processing system, upon which embodiments of the present disclosure may be implemented. Shown in FIG. 1 is sample-processing system 100.

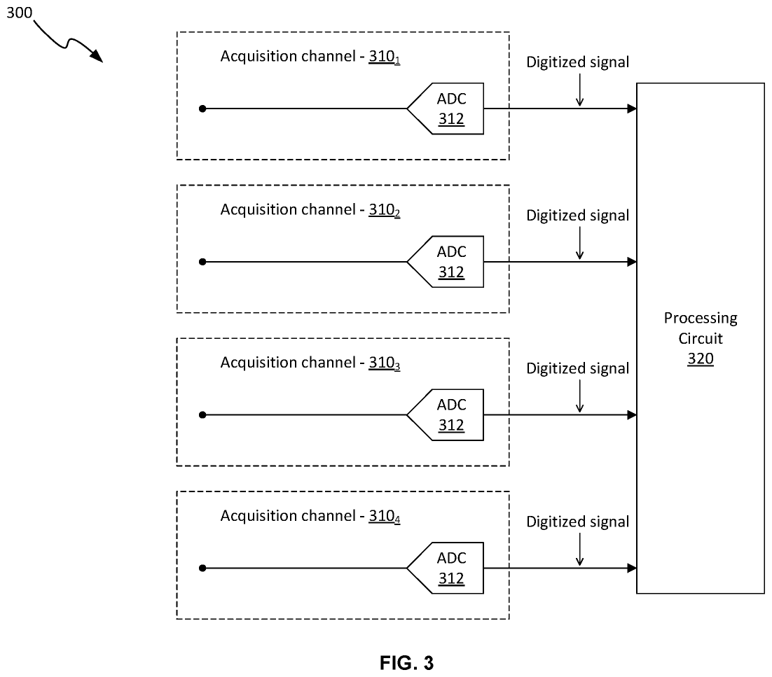

In the example implementation shown in FIG. 1, the sample-processing system 100 comprises an ion source 105, a differential mobility spectrometer (DMS) 115, a mass filter 120, an ion detector 125, voltage generator 117, and computing resources 130. The disclosure is not limited to such implementation, however, and as such in other implementations there may be some variations from the sample-processing system 100. For example, rather than being a separate component, the DMS 115 may be incorporated into, and be implement as a component of the mass filter 120. Further, in some implementations, some of the components illustrated in FIG. 3 may be eliminated and/or other components may added. For example, in some implementations, particularly TOF-based implementations, the DMS 115 may be omitted completely.

The ion source 105 may comprise an electrospray source, for example, and may serve to transfer processed samples or sample aliquots to the DMS 115. The DMS 115 separates ions based on their mobility and may comprise a planar DMS, high field asymmetric waveform ion mobility spectrometry (FAIMS), curved electrode DMS, etc. In a planar example, the DMS 115 may comprise two flat, parallel plate electrodes where a separation voltage (SV) may be applied between them such that ions may be transported through the DMS 115 by a transport gas flow and drift towards one of the electrodes. AC and DC signals may be applied to cause ions with a specific ion mobility to pass through while others are deflected towards the electrodes.

The separation voltage may be supplied to the DMS 115 by voltage generator 117, and may comprise voltages in the kV range yet still needing an accuracy of 2% or better, or 1% or better for best operation of the DMS. Calibration of voltage generators may require costly equipment and components. To alleviate this issue, the voltage generator 117 comprises RF and DC voltage generation circuitry as well as a peak detector circuit for calibrating this voltage.

The DMS 115 may deliver selected ions to the mass filter 120, which may comprise one or more multipole rod sets, for example. The mass filter 120 may filter ions based on m/z, fragment, and/or mass analyze ions. An example of a mass filter 120 is one or more quadrupole rod sets. The mass filter 120 may comprise a plurality of quadrupole rod sets (e.g., three rod sets) that may be configured to filter specific ions.

The ion detector 125 may comprise an electron multiplier detector, an electrostatic trap, a time-of-flight (TOF) mass spectrometer, optical detector, or other known ion detector used in mass spectrometry. Example electron multipliers comprise microchannel plate (MCP) detectors, channel electron multipliers, discrete dynode electron multipliers, among others. The ion detector 125 may be operable to detect ions passed through by the mass filter 120. In an embodiment, the mass filter 120 comprises at least one multipole rod set and the ion detector 125 comprises an electron multiplier detector, an optical detector, an electrostatic trap or a TOF mass spectrometer.

The computing resources 130 may comprise a controller 135 and data handler 140. The controller 135 may control the ion source 105, the DMS 115, the mass filter 120, and the ion detector 125. The data handler 140 may store data for processing samples, sample data, or data for analyzing sample data, and may receive an output signal from the ion detector 125.

The computing resources 130 may include any suitable data computation and/or storage device or combination of such devices. An example controller may comprise one or more microprocessors working together with storage to accomplish a desired function. The controller 135 and/or data handler may include at least one computing element that comprises at least one high-speed data processor adequate to execute program components for executing user and/or system-generated requests.

In various embodiments, sample-processing system 100 may be connected to one or more other computer systems across a network to form a networked system. The network may comprise a private network or a public network such as the Internet. In the networked system, one or more computer systems may store and serve the data to other computer systems. The one or more computer systems that store and serve the data may be referred to as servers or the cloud, in a cloud-computing scenario. The one or more computer systems may include one or more web servers, for example. The other computer systems that send and receive data to and from the servers or the cloud may be referred to as client or cloud devices, for example. It will be apparent to those of skill in the relevant arts that various embodiments of the present disclosure may utilize a computer as is known in the art.

The following descriptions of various implementations of the present teachings have been presented for purposes of illustration and description. It is not exhaustive and does not limit the present teachings to the precise form disclosed. Modifications and variations are possible in light of the above teachings or may be acquired from practicing of the present teachings. Additionally, the described implementation includes software but the present teachings may be implemented as a combination of hardware and software or in hardware alone. The present teachings may be implemented with both object-oriented and non-object-oriented programming systems.

In an example scenario, computing resources 130 may be operable to control a mass spectrometer system and/or operation thereof. Accordingly, the computing resources 130 may be operable to control circuitry for configuring the method parameters in mass spectrometry operations. Optimizing method parameters in differential mobility spectrometry is not trivial in a high throughput mass spectrometer system. The SelexION® and SelexION+® planar DMS devices are examples of DMS systems that provide additional selectivity. Other DMS devices, including curved electrode FAIMS-style DMS devices may also be used for this purpose. In general, the disclosure herein contemplates use of any type of device that offers selectivity based on continuous filtering ion mobility and uses the term DMS to refer to these types of devices.

The difficulty in configuring SV is that it involves high accuracy at high speeds, which is typically not possible without calibration. This may be particularly true when trying to analyze a panel of compounds simultaneously. The incorporation of the voltage generation module 117 enables the generation of high-speed, high-accuracy RF signals.

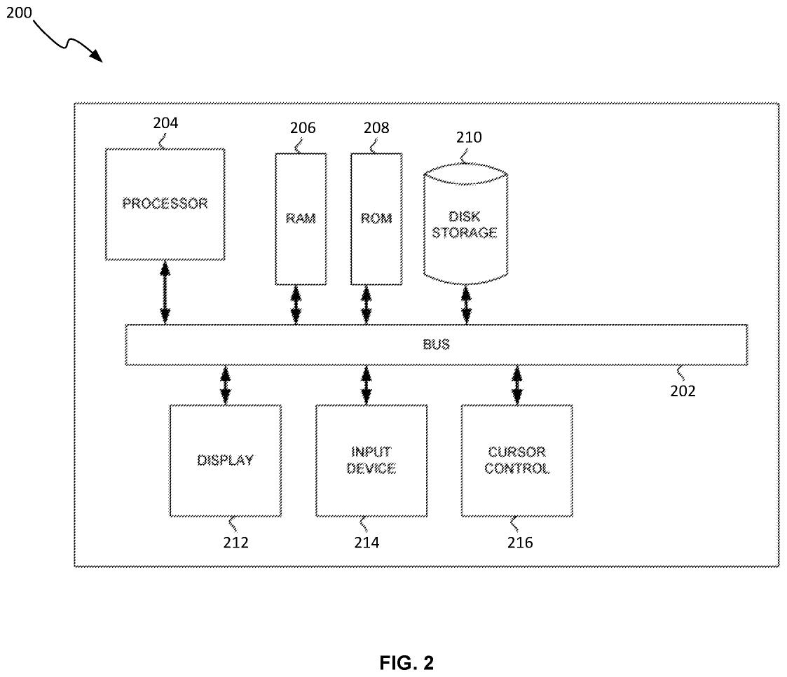

FIG. 2 illustrates a high-level block diagram of an example computer system, upon which embodiments of the present disclosure may be implemented. Shown in FIG. 2 is computer system 200.

The computer system 200 may comprise a bus 202 or other communication mechanism for communicating information, and a processor 204 coupled with bus 202 for processing information. The computer system 200 may also comprise a memory 206, which can be a random access memory (RAM) or other dynamic storage device, coupled to bus 202 for storing instructions to be executed by processor 204. Memory 206 also may be used for storing temporary variables or other intermediate information during execution of instructions to be executed by processor 204. The computer system 200 may comprise a read only memory (ROM) 208 or other static storage device coupled to bus 202 for storing static information and instructions for processor 204. A storage device 210, such as a magnetic disk or optical disk, may be provided and coupled to bus 202 for storing information and instructions.

The computer system 200 may be coupled via bus 202 to a display 212, such as a light emitting diode (LED) or liquid crystal display (LCD), for displaying information to a computer user. An input device 214, including alphanumeric and other keys, may be coupled to bus 202 for communicating information and command selections to processor 204. Another type of user input device is cursor control 216, such as a mouse, a trackball or cursor direction keys for communicating direction information and command selections to processor 204 and for controlling cursor movement on display 212. This input device typically has two degrees of freedom in two axes, a first axis (i.e., x) and a second axis (i.e., y), that allows the device to specify positions in a plane.

The computer system 200 can perform the present teachings. Consistent with certain implementations of the present teachings, results are provided by the computer system 200 in response to processor 204 executing one or more sequences of one or more instructions contained in memory 206. Such instructions may be read into memory 206 from another computer-readable medium, such as storage device 210. Execution of the sequences of instructions contained in memory 206 causes processor 204 to perform the process described herein. Alternatively, hard-wired circuitry may be used in place of or in combination with software instructions to implement the present teachings. Thus, implementations of the present teachings are not limited to any specific combination of hardware circuitry and software.

In various embodiments, the computer system 200 may be connected to one or more other computer systems, like the computer system 200, across a network to form a networked system. The network may comprise a private network or a public network such as the Internet. In the networked system, one or more computer systems can store and serve the data to other computer systems. The one or more computer systems that store and serve the data can be referred to as servers or the cloud, in a cloud-computing scenario. The one or more computer systems can include one or more web servers, for example. The other computer systems that send and receive data to and from the servers or the cloud can be referred to as client or cloud devices, for example.

The term “computer-readable medium” as used herein refers to any media that participates in providing instructions to processor 204 for execution. Such a medium may take many forms, including but not limited to, non-volatile media, volatile media, and transmission media. Non-volatile media includes, for example, optical or magnetic disks, such as storage device 210. Volatile media includes dynamic memory, such as memory 206. Transmission media includes coaxial cables, copper wire, and fiber optics, including the wires that comprise bus 202.

Common forms of computer-readable media or computer program products include, for example, a floppy disk, a flexible disk, hard disk, magnetic tape, or any other magnetic medium, a CD-ROM, digital video disc (DVD), a Blu-ray Disc, any other optical medium, a thumb drive, a memory card, a RAM, PROM, and EPROM, a FLASH-EPROM, any other memory chip or cartridge, or any other tangible medium from which a computer can read.

Various forms of computer readable media may be involved in carrying one or more sequences of one or more instructions to processor 204 for execution. For example, the instructions may initially be carried on the magnetic disk of a remote computer. The remote computer can load the instructions into its dynamic memory and send the instructions over a communications link. A modem local to the computer system 200 can receive the data on the link and use an infrared transmitter to convert the data to an infrared signal. An infrared detector coupled to bus 202 can receive the data carried in the infrared signal and place the data on bus 202. Bus 202 carries the data to memory 206, from which processor 204 retrieves and executes the instructions. The instructions received by memory 206 may optionally be stored on storage device 210 either before or after execution by processor 204.

In accordance with various embodiments, instructions configured to be executed by a processor to perform a method may be stored on a computer-readable medium. The computer-readable medium may comprise a device that stores digital information. For example, a computer-readable medium includes a compact disc read-only memory (CD-ROM), universal serial bus (USB) drive, or other storage device as is known in the art for storing software. The computer-readable medium may be accessed by a processor suitable for executing instructions configured to be executed.

The following descriptions of various implementations of the present teachings have been presented for purposes of illustration and description. It is not exhaustive and does not limit the present teachings to the precise form disclosed. Modifications and variations are possible in light of the above teachings or may be acquired from practicing of the present teachings. Additionally, the described implementation includes software but the present teachings may be implemented as a combination of hardware and software or in hardware alone. The present teachings may be implemented with both object-oriented and non-object-oriented programming systems.

In an example scenario, the computer system 200 may be operable to control a mass spectrometer system. For example, the computer system 200 may corresponds to, and/or may be an example implementation of the computing resources 130 (or portion thereof) as described with respect to FIG. 1. Accordingly, the computer system 200 may be operable to control circuitry for facilitating injecting of ions (e.g., by applying RF and DC voltages). The computer system 200 may also be operable for reading measurements based on the injected ions, such as detector outputs, for example.

In various embodiments in accordance with the present disclosure, time-of-flight (TOF) mass spectrometry may be optimized and/or enhanced, such as by improving the reliability of measurements and/or information generated or obtained based on time-of-flight (TOF) mass spectrometry and/or reducing time required therefor, particularly by incorporating use of Gaussian fitting, particularly second (2nd) degree polynomial fitting, in the course of processing of digitized signals generated from ions detection, and doing so in real-time, to enhance obtaining measurements and/or information based on time-of-flight (TOF) mass spectrometry.

In this regard, Gaussian fitting entails use of curve fitting based processing for constructing a curve or mathematical function, particularly Gaussian one, which may be the best fit to a series of data points, corresponding to, in the context of time-of-flight (TOF) mass spectrometry, digitized signals generated during the ion detection phase. Such curve fitting may entail complex operations or functions (e.g., interpolation, smoothing, etc.) for determining exact fit to the data is required, so that the Gaussian function that most accurately fits the data is constructed.

Use of Gaussian fitting, particularly in in real-time as described herein, may allow for addressing various problems that may arise in any existing approaches. For example, one of the factors contributing to achieved resolution and dynamic range of time-of-flight (TOF) mass spectrometer is the precision of processing the digitized signal acquired from the ions detector. More precise process methods may be more intensive, demanding more processor resources; they also require a larger number of digitized samples per waveform, so they can be prohibitive for processing, in real-time, a significant rate of detected ions.

Nonetheless, use of Gaussian fitting may still be desirable as it offer various advantages. For example, use of Gaussian fitting allows for calculating with high precision the ions time of arrival (e.g., effect on resolution) as well as signal intensity (e.g., measure of number of ions arriving at detector at the same time, effect on dynamic range). In instances where the signal intensity saturates the acquisition subsystem (e.g., the analog-to-digital convertors (ADCs)), use of Gaussian fitting allows for estimating the signal original intensity (e.g., effect on dynamic range). It also provides good results discriminating between ions with very close time-of-flight (TOF) (e.g., effect on resolution).

In implementations based on the present disclosure, Gaussian fitting algorithm are used in conjunction with the processing of signals corresponding to detected ions. Such algorithm may be configured to use processor resources in the system very efficiently, thus allowing for processing in real-time of all ions generated by the mass spectrometer, up to a significant rate. In an example use scenario, ions are first identified, in the digitized signal acquired from the ions detector, such as by means of zero crossing and gradient threshold of smoothened first derivative, thus allowing for discriminating between ions arriving spaced at full width at half maximum (FWHM) of signal generated by a single ion.

The signal is then processed, in real-time, by means of Gaussian fitting, which results in precise information about ions arrival times and signal intensity. Gaussian fitting also allows reconstruction of signal that saturates (exceeds the input range) of the acquisition system (digitizer). In this regard, the Gaussian fitting algorithm operates on vectors of data, which allows for taking advantage of highly capable processors, which may be configured for supporting vector operations capabilities. Such processors may assure fast execution, and may be capable of processing, in real-time, a significant rate of detected ions. In example embodiment that utilizes multiple acquisition channels, is illustrated and described in more detail with respect to FIG. 3.

FIG. 3 illustrates a high-level block diagram of an example data acquisition and conversion system, in accordance with an example embodiment of the present disclosure. Shown in FIG. 3 is data acquisition and conversion system 300.

The data acquisition and conversion system 300 may be implemented or incorporated into, and may constitute component of an apparatus configured for performing time-of-flight (TOF) mass spectrometry, such as the system 100 of FIG. 1. In this regard, the data acquisition and conversion system 300 may be configured for performing and/or supporting time-of-flight (TOF) mass spectrometry, and particularly for optimizing time-of-flight (TOF) mass spectrometry by incorporating use of Gaussian fitting of digitized signal from ions detection, and doing so in real-time, to enhance obtaining measurements and/or information based on time-of-flight (TOF) mass spectrometry.

The data acquisition and conversion system 300 may be implemented as multi-channel based system, with a number of channels that may be configured to handle concurrently (and, optionally, independently), acquisition and processing of ions during time-of-flight (TOF) mass spectrometry. In this regard, each of the channels may be configured for acquiring the ions, which results in generating analog signals, and digitizing these signals—that is, generating corresponding digitized signals. The digitized signals may then processed, similarly concurrently (and optionally independently). This may allow for increasing sampling rate even while supporting enhancement solutions in accordance with the present disclosure—that is, using Gaussian fitting, particularly using second (2nd) degree polynomial fitting, and in real-time for generating measurements and/or other information relating to the ion detection in the course of time-of-flight (TOF) mass spectrometry.

The data acquisition and conversion system 300 may correspond to multiple components of the system 100 of FIG. 1. For example, the data acquisition and conversion system 300 may correspond to and/or span at least portions of the ion detector 125 and the computing resources 130. Alternatively, the ion detector 125 may be configured to handle the basic ion detection, with the data acquisition and conversion system 300 handling all remaining acquisition and processing functions, and a such may be corresponding to and/or by implemented fully within the computing resources 130.

In the example embodiment illustrated in FIG. 3, the data acquisition and conversion system 300 (or portion thereof illustrated in FIG. 3) comprises four (4) acquisition channel paths 3101-3104 and processing circuit 320. Each of the comprises suitable circuitry for acquiring ions during the ion detection phase, which entail generating analog signals based on such detection, and then generating corresponding digitized signals. In this regard, each of the acquisition channel paths 3101-3104 may comprise analog-to-digital convertor (ADC) for performing the required digitization (ADC circuits 3121-3124). The processing circuit 320 comprises suitable circuitry for processing digitized signals generated and outputted by the acquisition channel paths 3101-3104. In an example embodiment, the data acquisition and conversion system 300 may be implemented as, and may be configured to support acquisition and conversion at 14-bit, 2.5G samples/second, via each of the four (4) channels—that is, via each of the acquisition channel paths 3101-3104.

The data acquisition and conversion system 300 may be configured to implement and use Gaussian fitting algorithm, as described herein, to provide real-time processing of the digitized signals. In an example use scenario, the data acquisition and conversion system 300 may apply the Gaussian fitting algorithm with signals acquired continuously, by each of 14-bit 2.5G Samples/second ADC in the 4 channels, from an ions detector in the time-of-flight (TOF) mass spectrometry instrument. In this regard, the signal (event) generated by an ion or multiple ions arriving at the ions detector at the same time may have a Gaussian shape (e.g., with a 1.7 nanoseconds full width at half maximum full width at half max (FWHM)). High rate processing may be achieved by use of such algorithm and setup. For example, in some instances, a processing rate of 12 Mega events per second, for the combined four channels, may be achieved.

Enhanced processing signals for time-of-flight (TOF) detection as described herein may lead to improved mass accuracy and intensity measurements. These improvements may require excessive computing time and are not practical for real-time analysis or real-time conversion of signals to a useful data format for downstream processing. The use of the Gaussian fitting algorithm, particularly in conjunction with the described design (with parallel channels), along with use of advanced processing techniques (e.g., use of matrix calculations performed by processors with suitable capabilities and/or architecture (e.g., AVX instructions on Intel® microarchitecture)) enables performing more sophisticated signal processing than previously possible. This may allow for solve such problems as: 1) finding an accurate event position and intensity of a TOF signal digitized using ADC; 2) accurate estimation of real event position and intensity from saturated signal, thus increasing linear dynamic range (proportion between highest and lowest detected event intensities); and 3) deconvolution of coalesced peaks. Each of these problems may be of a significant practical importance.

The processing of the digitized signals may comprise performing various steps (e.g., via the processing circuit 320) to identify the data. For example, the processing may comprise performing event finding and event processing. The event finding may comprise applying zero crossing of smoothened first derivative of acquired signal. The event finding may use a threshold on the gradient of smoothened first derivative in order to select only events in a certain range of full widths at half maximum, for example 1.7 nanoseconds. This may entail deconvolution of events spaced at full width at half maximum (FWHM) and filtering noise (e.g., narrow spikes). Event processing may comprise applying Gaussian fit, particularly second (2nd) degree polynomial fitting, such as by use of least squares, via QR factorization for example. This may yield position, amplitude and width of the pulses. Nonetheless, the disclosure is not limited to use of QR factorization, and as such other suitable approaches or methodologies may be used in some implementations—that is, where polynomial fit with least squares is used but with other mathematical method(s) being used for calculating the solution(s) to the system of equations. In other words, it should be understood that the use of QR factorization as described herein in only one example approach of carrying the mathematical solutions for the least squares problem, and as such use of QR factorization may not be critical and thus is not be required for each and every implementation in accordance with the present disclosure. Accordingly, in some example implementations, along with or instead of QR factorization as described herein in determining the matrix pseudoinverse towards the solutions other mathematical methods that similarly applicable may be used in solving the least squares system of equation.

Data may be provided as ‘position-amplitude [area]’ pairs or spectrum (e.g., histogram, distribution of events intensities over time of flight, such as with as low as 5 picoseconds bins). This may be done using histogram with equal binning or Gaussian binning. In some instances, data acquisition and processing may comprise vectorization of processing algorithms (e.g., convolution, matrix multiplication).

In an example use scenario, measurements may be obtained, and the corresponding signals and data based thereon may be processed. Measurements may be performed with signal generated by an Arbitrary Waveform generator (AWG). The signal may be in form of burst of events emulating real detector signal: Gaussian shape, with 1.7 nanoseconds FWHM and various amplitudes. In order to characterize the processing algorithm quality attributes, evaluation of the following parameters may be performed: event position precision (resolution) and accuracy, linear dynamic range (LDR, or ratio between the largest and the smallest signal identifiable as being generated by an ion or group of ions arriving at the detector at the same time)), measurements stability, events deconvolution, and extended LDR (e.g., saturation correction).

In an example test, precision of measurement of position of event arriving at detector in 94 microseconds may be (all numbers are picoseconds standard deviation stdev): event with intensity of 0.52% of FS: 112 psec; intensity of 1% of FS: 69 psec; intensity of 2% of FS: 34 psec; event with intensity from 25% of FS up to FS: 13.7 psec. To be noted that precision of floating point calculations is 5.6 picoseconds (or 2\hat{ }−24 of 94e6 picoseconds time of flight chosen as benchmark for test measurements).

In an example test, precision of measuring the event amplitude may be (all numbers are amplitude standard deviation as percentage of the event amplitude): event with intensity of 0.52% of FS: 13.1%; intensity of 1% of FS: 7.5%; intensity of 2% of FS: 3.8%; event with intensity of 25% of FS up to FS: 0.4%. To be noted that system white noise stdev was measured as 5.4 lsb, or 12.8% of event with amplitude of 0.52% of FS, or 7.2% of the 1% FS event.

In an example test, precision of measuring the event width may be (all numbers are picoseconds standard deviation): event with intensity of 0.52% of FS: 350 psec; intensity of 1% of FS: 240 psec; intensity of 2% of FS: 108 psec; intensity of 25% of FS up to FS: 21 psec.

With respect to linear dynamic range (LDR), AWG burst of events emulating real detector signal may be used, first with events of amplitude 42 lsb (least significant bit), or 0.51% of the ADC Full Scale, and second with 4523 lsb, or 55% of the ADC Full Scale; and the events are then processed and accumulated (e.g., in histogram), such as over 9990 extractions. In an example test, the ‘sum intensity’ for a peak of 42 lsb events may be measured as 4.072e5, the ‘sum intensity’ for a peak of 4522 lsb events may be measured as 4.533e7. These measures correspond to ratio of 111.2, compared with an expected ratio between intensities of 108. Thus, only about 3% of the 42 lsb events were not detected, which leads us to consider the event with intensity of 42 lsb as the smallest detectable event with our system. To be noted that the white noise stdev of the system was measured as being 5.4 lsb stdev.

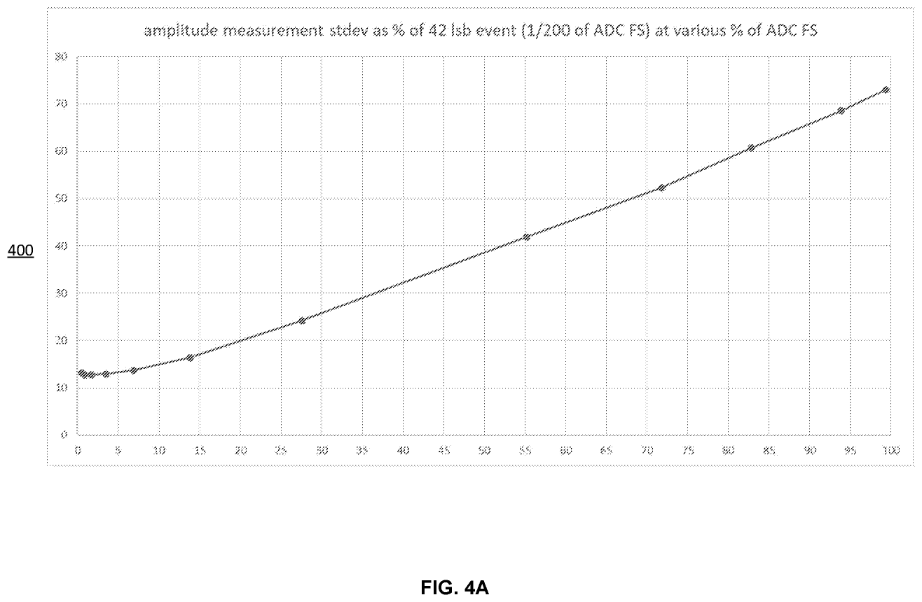

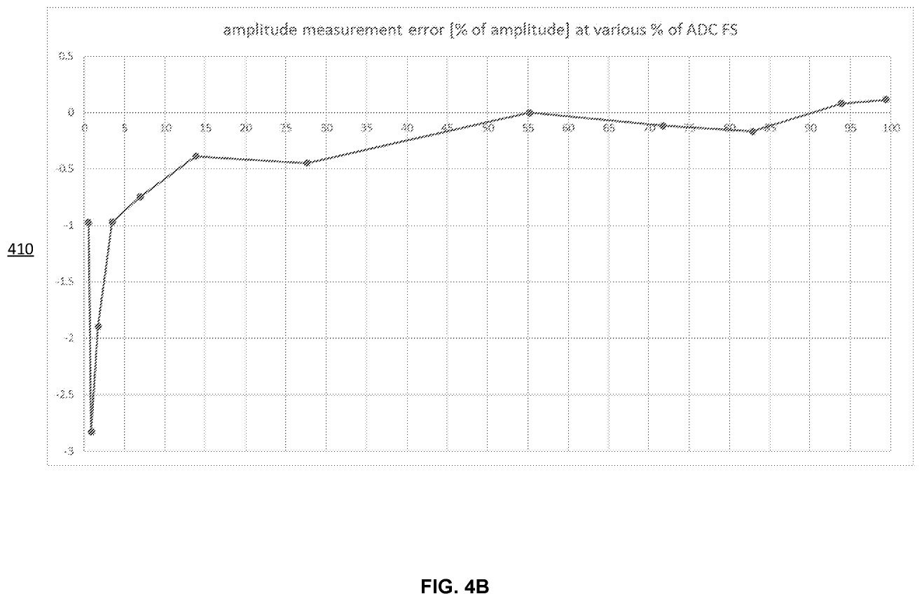

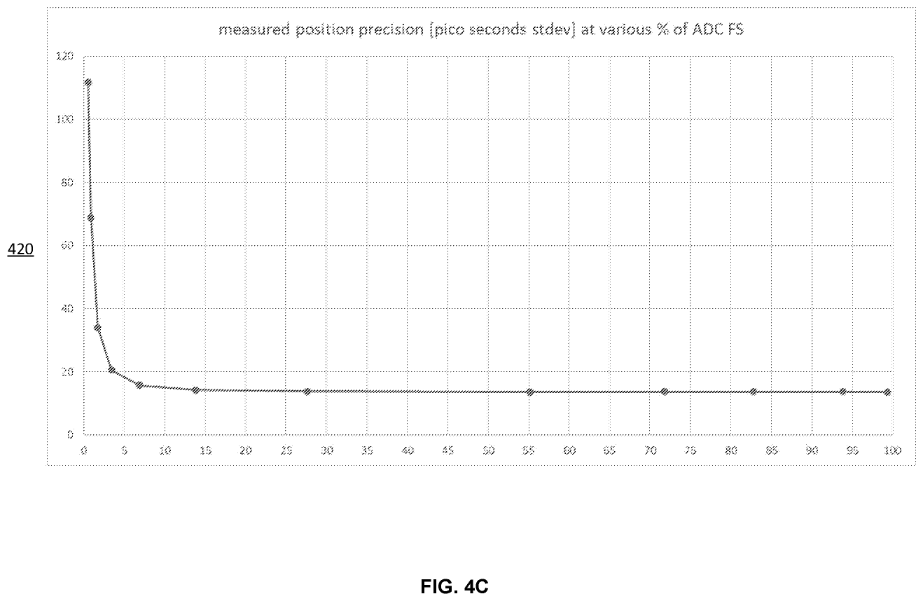

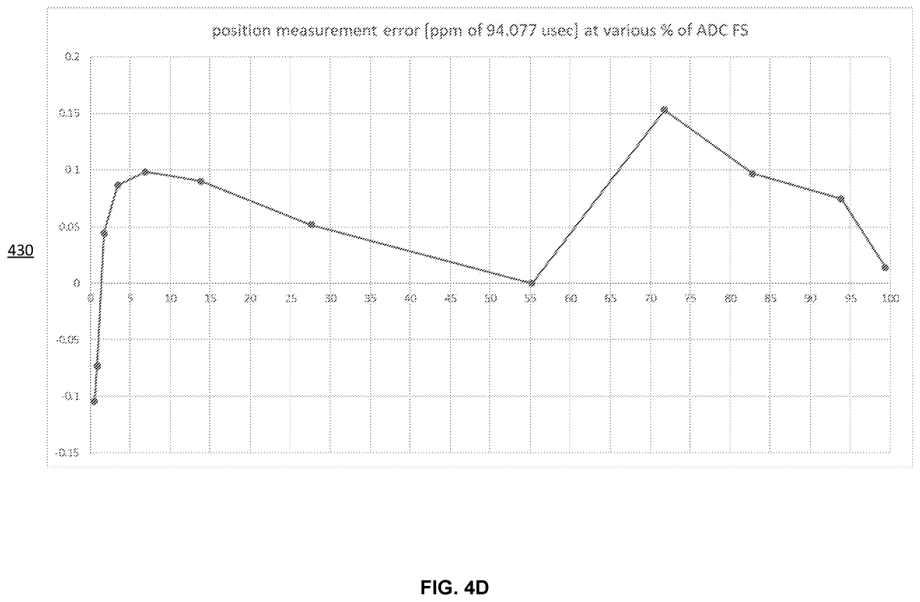

Precision and accuracy of event position and amplitude measurements, stability of measurements, events deconvolution, and extended LDR (e.g., saturation correction) are described and illustrated in more detail with respect to FIGS. 4A-10B.

FIG. 4A-4D illustrate plots of example event amplitude and position measurements precision and accuracy over analog-to-digital convertor (ADC) full scale (FS), in accordance with an example embodiment of the present disclosure.

FIG. 4A illustrates a plot of example amplitude measurement precision over analog-to-digital convertor (ADC) full scale (FS) for a test signal with 1.7 nsec full width at half max (FWHM), in accordance with an example embodiment of the present disclosure. Shown in FIG. 4A is plot 400, illustrating stdev of amplitude measurements as % of a 42 lsb event (or 1/200 of ADC Full Scale) (on the y-axis) as function of event amplitudes (in percentage of ADC FS, on the x-axis).

In this regard, plot 400 (and similarly some of the plot in the following figures) illustrates a positive polarity pulse with baseline around 0 (zero). The disclosure is not so limited, however. For example, in other possible scenarios the pulse polarity may be negative, or the baseline may be shifted to a positive value, or to a negative value. This, while illustrated plots may refer to positive polarity pulses with zero baseline, the disclosure may similarly be applied to such other scenarios. Plot 400 (and subsequent similar plots) illustrate ADC Full Scale (FS) data and other related data, such pulse amplitude, pulse baseline (reference level) and pulse polarity.

With respect to ADC Full Scale (FS), for 14 bits of resolution, for example, the resulting analog-to-digital conversion may yield 2\hat{ }14 codes—that is 16384 codes—over the Full Scale. When 2′ complement representation is used, the largest possible code may be +8191 and the smallest −8192, with the 0 being in the middle of the range −FS to +FS. Pulse baseline is the signal presented at the ADC converter input in the absence of any detector ion pulses, more specifically the average in time of this signal such that the noise effect is eliminated. Pulse amplitude is the difference between the pulse peak level and the baseline. Pulse polarity may be positive or negative, corresponding on the sign of the amplitude.

FIG. 4B illustrates a plot of example amplitude measurement accuracy over analog-to-digital convertor (ADC) full scale (FS) for a test signal with 1.7 nsec FWHM, in accordance with an example embodiment of the present disclosure. Shown in FIG. 4B is plot 410, illustrating the error in amplitude measurements as % of expected (real) amplitude values (on the y-axis) as function of event amplitudes (in percentage of ADC FS, on the x-axis). In this regard, as illustrated in plot 410, amplitude measured at 55.2% of FS is taken as reference for real amplitudes. Table 1, below, includes the data used in generating plots 400 and 410:

TABLE 1
Test based data for amplitude measurement linearity over ADC FS

| | | | | | amplitude | amplitude |
|---|---|---|---|---|---|---|
| | | | | amplitude | stdev as % | measured |
| | | | measured | stdev as % | of measured | error as % of |
| | amplitude | expected | amplitude | of measured | amplitude of | expected |
| % FS | measured | amplitude | stdev | amplitude | 42 lsb event | amplitude |
| 99.37543 | 8131.730173 | 8140.835495 | 31.24883133 | 0.384282688 | 72.9907034 | 0.111847522 |
| 93.85458 | 7682.530088 | 7688.566857 | 29.34796702 | 0.382009139 | 68.55068381 | 0.078516183 |
| 82.81286 | 6795.419122 | 6784.029579 | 26.00593558 | 0.382698037 | 60.74440066 | −0.16788757 |
| 71.77115 | 5886.333309 | 5879.492302 | 22.38493804 | 0.380286621 | 52.28651132 | −0.116353692 |
| 55.20857 | 4522.686386 | 4522.686386 | 17.93568621 | 0.396571521 | 41.893994 | 0 |
| 27.60429 | 2271.465913 | 2261.343193 | 10.35585307 | 0.455910565 | 24.1890966 | −0.447641887 |
| 13.80214 | 1135.035702 | 1130.671597 | 7.017073234 | 0.618224891 | 16.39040852 | −0.385974652 |
| 6.901072 | 569.5545663 | 565.3357983 | 5.873163969 | 1.031185477 | 13.71847685 | −0.746241092 |
| 3.450536 | 285.4101501 | 282.6678991 | 5.541271494 | 1.941511713 | 12.94324577 | −0.970131713 |
| 1.725268 | 144.0156008 | 141.3339496 | 5.461373698 | 3.79220978 | 12.75662131 | −1.89738645 |
| 0.862634 | 72.66394089 | 70.66697479 | 5.440282075 | 7.486907548 | 12.70735571 | −2.825883109 |
| 0.51758 | 42.81207041 | 42.40018487 | 5.603000948 | 13.08743281 | 13.08743281 | −0.971423912 |
| 0.431317 | 38.05444813 | 35.33348739 | 5.235284873 | 13.75735329 | 12.22852533 | −7.700798705 |

FIG. 4C illustrates a plot of example measured position precision over analog-to-digital convertor (ADC) full scale (FS) for a test signal with 1.7 nsec FWHM, in accordance with an example embodiment of the present disclosure. Shown in FIG. 4C is plot 420, illustrating measured position stdev as function of event amplitudes (as percentage of ADC FS, on the x-axis).

FIG. 4D illustrates a plot of example measured position accuracy over analog-to-digital convertor (ADC) full scale (FS) for a test signal with 1.7 nsec FWHM, in accordance with an example embodiment of the present disclosure. Shown in FIG. 4D is plot 430, illustrating the error in position measurements in parts per million (ppm) of expected position of 54.48 micro seconds as function of event amplitudes (in percentage of ADC FS, on the x-axis). In this regard, as illustrated in plot 430, position measured at 55.2% of FS is taken as reference for real position. Table 2, below, includes the data used in generating plots 420 and 430:

TABLE 2
Test based data for position measurement
precision, accuracy over ADC FS

| % FS | position | position stdev [psec] | position error [ppm] |
|---|---|---|---|
| 99.37543 | 94076938.2 | 13.5802909 | 0.014075913 |
| 93.85458 | 94076943.88 | 13.6772676 | 0.07453175 |
| 82.81286 | 94076945.97 | 13.7095657 | 0.096704427 |
| 71.77115 | 94076951.26 | 13.6724574 | 0.152925034 |
| 55.20857 | 94076936.87 | 13.5940191 | 0 |
| 27.60429 | 94076941.71 | 13.8341204 | 0.051404071 |
| 13.80214 | 94076945.34 | 14.2027696 | 0.089977884 |
| 6.901072 | 94076946.13 | 15.7092015 | 0.098365301 |
| 3.450536 | 94076945.02 | 20.5295588 | 0.086573091 |
| 1.725268 | 94076941.01 | 33.9673134 | 0.043971656 |
| 0.862634 | 94076929.97 | 68.8176207 | −0.073369138 |
| 0.51758 | 94076927.09 | 111.765676 | −0.104012275 |

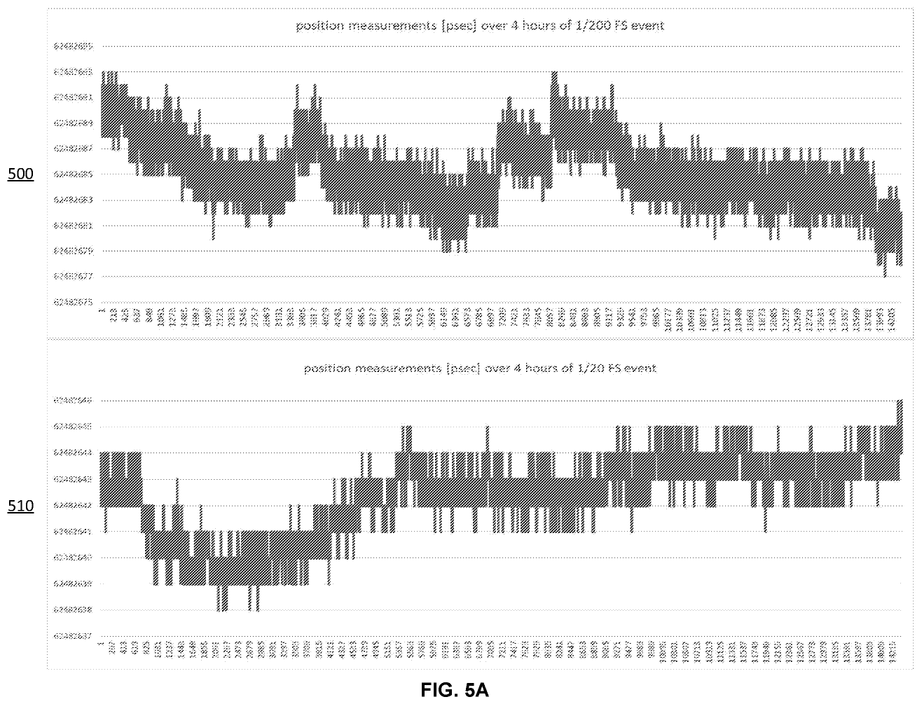

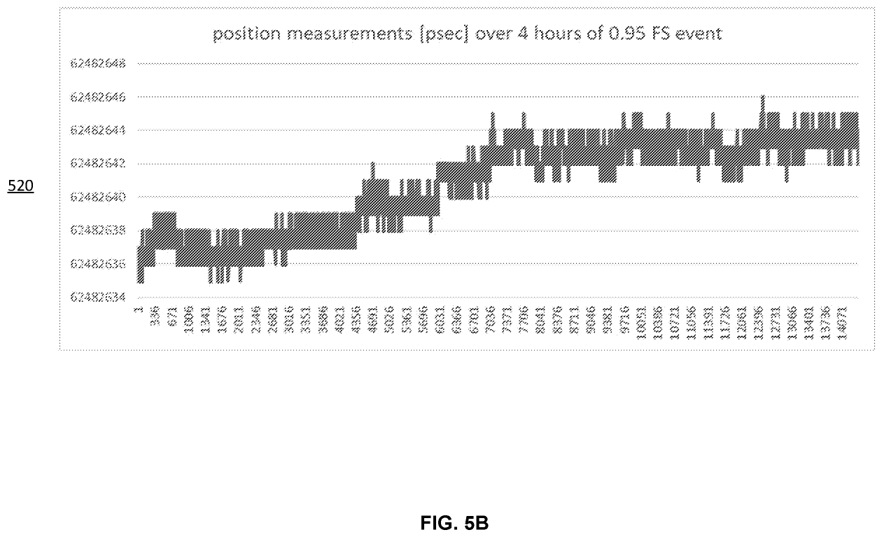

FIGS. 5A-5B illustrate plots of example tests for measurements stability, in accordance with an example embodiment of the present disclosure. Shown in figures are plots 500, 510, and 520, corresponding to four hours stability testing; each point on the graph is the average of 9000 position measurements (at a rate of 9000 measurements per second) for an event arriving at 62.4826 microseconds after trigger. Plot 500 shows example results for event of amplitude of 41 ADC lsb (0.5% of FS), with 2.37 psec stdev of position averages over 9000 extractions and 0.48 lsb stdev of amplitude averages (or 1.05% of event amplitude). Plot 510 shows example results for event of amplitude of 450 lsb (5.5% of FS), with 1.45 psec stdev of position averages over 9000 extractions and 0.53 lsb stdev of amplitude averages (0.1% of event amplitude). Plot 520 shows example results for event of amplitude of 7800 lsb (95% of FS), with 2.65 psec stdev of position averages over 9000 extractions and 2.5 lsb stdev amplitude averages (or 0.03% of event amplitude).

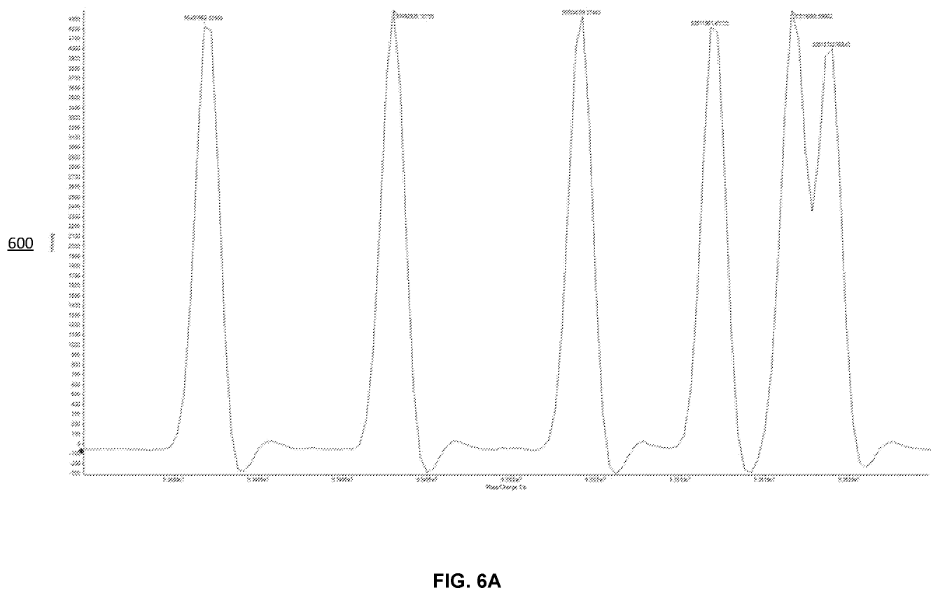

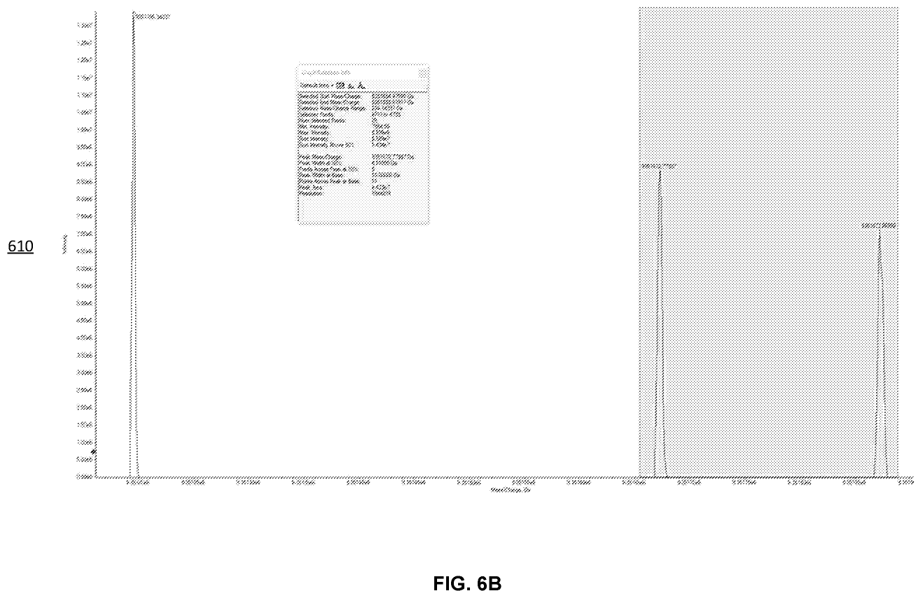

FIGS. 6A-6B illustrate plots of example of deconvolution of events spaced at full width at half max (FWHM) distance, in accordance with an example embodiment of the present disclosure.

Shown in FIG. 6A-6B are plots 600 and 610, illustrating deconvolution of events spaced at FWHM, with plot 600 particularly showing events of 4484 lsb amplitude (e.g., approximately ½ of ADC full scale) and 1.5 nsec full width at half maximum (FWHM) width (thus, e.g., events #5 and #6 are separated by FWHM), and plot 610 showing corresponding accumulated spectrum of intensities over 9990 extractions (on the y-axis) as function of time in 10 psec units (on the x-axis). In this regard, as illustrated in plots 600 and 610, sum intensities for events #5 and #6 are 4.43e7 and 4.16e7 respectively, for a total of 8.5e7 for both events; expected value is 4.48 e7.

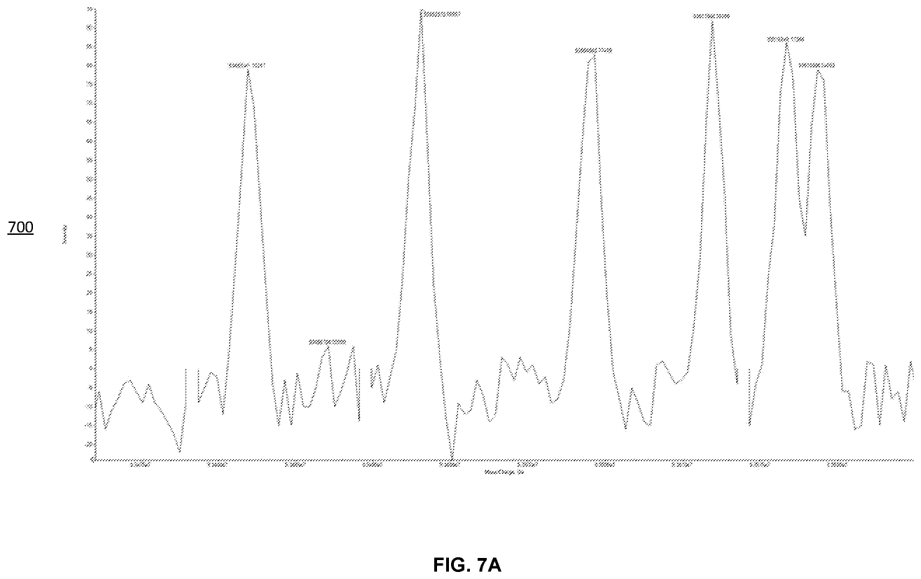

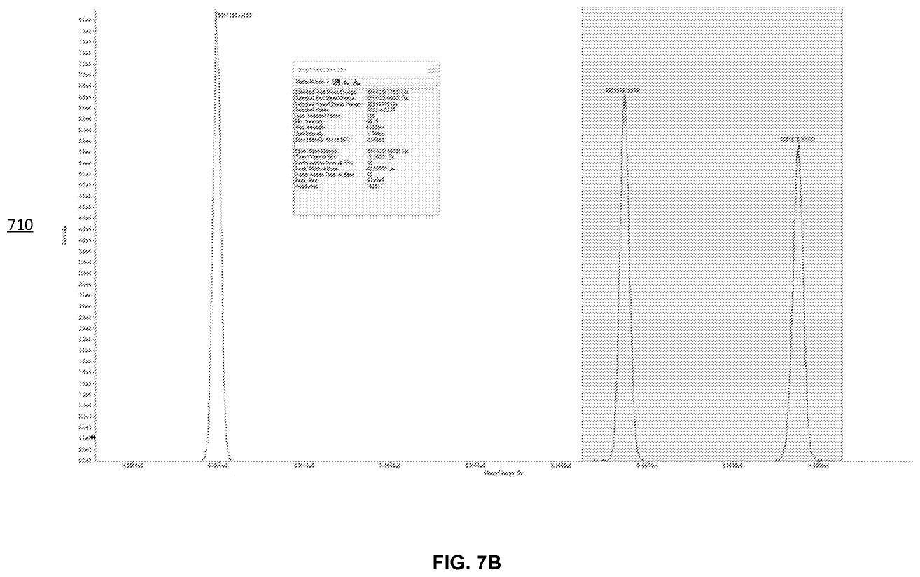

FIG. 7A-7B illustrate plots of example of deconvolution of events spaced at full width at half max (FWHM) distance, in accordance with an example embodiment of the present disclosure.

Shown in FIG. 7A-7B are plots 700 and 710, illustrating deconvolution of events spaced at FWHM, with plot 700 particularly showing events of 90.5 lsb amplitude (e.g., approximately 1/100 of ADC full scale) and 1.5 nsec full width at half maximum (FWHM) width (thus, e.g., events #5 and #6 are separated by FWHM), and plot 710 showing corresponding accumulated spectrum of intensities over 9990 extractions (on the y-axis) as function of time in 10 psec units (on the x-axis). In this regard, as illustrated in plots 700 and 710, sum intensities for events #5 and #6 are 9.05e5 and 8.39e5 respectively, for a total of 1.75e6 for both events; expected value is 9.04 e7.

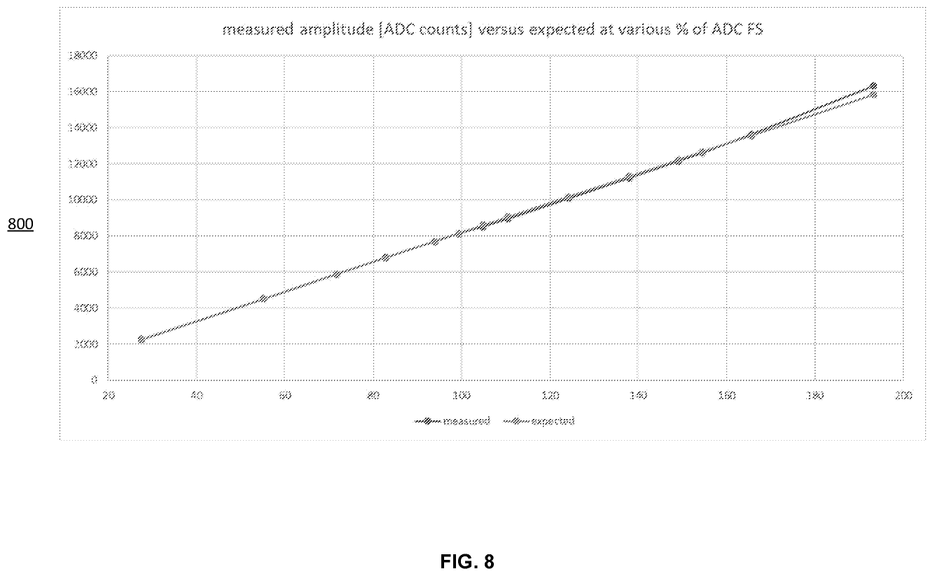

FIG. 8 illustrates a plot of example results of estimated intensity of captured event with amplitude exceeding the analog-to-digital convertor (ADC) full scale (FS), in accordance with an example embodiment of the present disclosure. Shown in FIG. 8 is plot 800, illustrating measured and real (expected) amplitudes (on the y-axis) as function of the percentage of ADC FS (on the x-axis), for an example event saturation correction.

The following paragraphs illustrate the precision and accuracy of estimating the position and intensity of the signal that exceeds the range of ADC Full Scale (saturation correction).

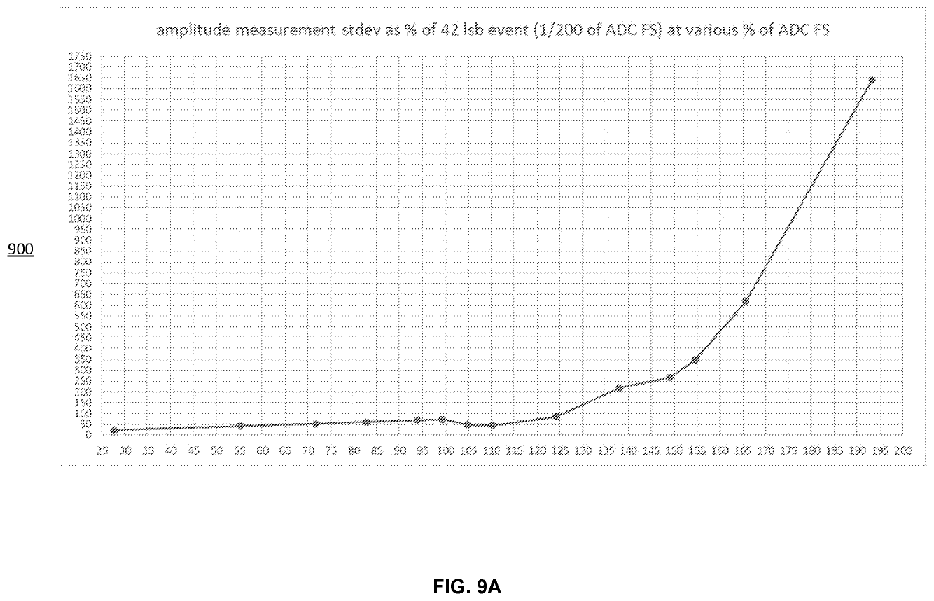

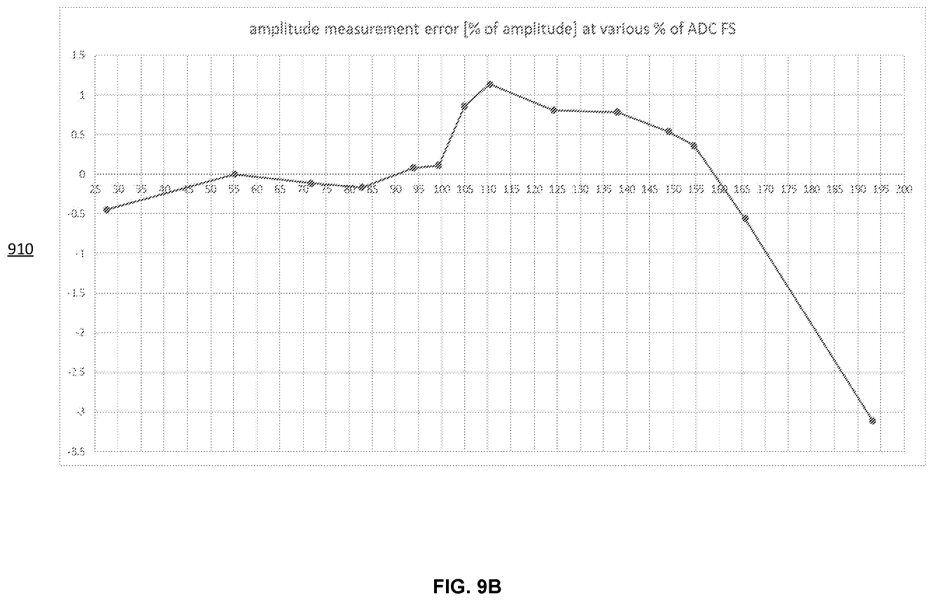

FIG. 9A illustrates a plot of example events amplitude measurement precision for events exceeding the analog-to-digital convertor (ADC) full scale (FS), in accordance with an example embodiment of the present disclosure. Shown in FIG. 9A is plot 900, illustrating the standard deviation of amplitude measurements as % of a 42 lsb event, considered to be the smallest identifiable event (on the y-axis) as function of the percentage of ADC FS (on the x-axis), for an example event saturation correction.

FIG. 9B illustrates a plot of example events amplitude measurement accuracy for events exceeding the analog-to-digital convertor (ADC) full scale (FS), in accordance with an example embodiment of the present disclosure. Shown in FIG. 9B is plot 910, illustrating the error in events intensity measurements as % of expected (real) intensity values (on the y-axis) as function of the percentage of ADC FS (on the x-axis), for an example event saturation correction. As illustrated in plot 910, events amplitude measured at 55.2% of FS is taken as reference for real areas. Table 3, below, includes the data used in generating plots 900 and 910:

TABLE 3
Test based data for amplitude measurement precision
and accuracy for events exceeding the ADC FS

| | | | | amplitude | amplitude |
|---|---|---|---|---|---|
| | | | | stdev as % of | measured |
| | | | measured | measured | error as % of |
| | amplitude | expected | amplitude | amplitude of | expected |
| % FS | measured | amplitude | stdev | 42 lsb event | amplitude |
| 193.23 | 16322.31455 | 15829.40235 | 702.3740367 | 1640.598154 | −3.113902797 |
| 165.6257 | 13644.35958 | 13568.05916 | 264.7036621 | 618.2921302 | −0.562353232 |
| 154.584 | 12617.82487 | 12663.52188 | 149.0711742 | 348.1989374 | 0.360855495 |
| 149.0631 | 12145.57934 | 12211.25324 | 114.3492217 | 267.0957527 | 0.537814572 |
| 138.0214 | 11218.0693 | 11306.71597 | 93.8005318 | 219.0983312 | 0.784017759 |
| 124.2193 | 10093.71354 | 10176.04437 | 36.65363878 | 85.61519785 | 0.809065165 |
| 110.4171 | 8942.397596 | 9045.372773 | 19.40746962 | 45.33177077 | 1.138429325 |
| 104.8963 | 8519.405473 | 8593.104134 | 20.92073459 | 48.86643976 | 0.85764888 |
| 99.37543 | 8131.730173 | 8140.835495 | 31.24883133 | 72.9907034 | 0.111847522 |
| 93.85458 | 7682.530088 | 7688.566857 | 29.34796702 | 68.55068381 | 0.078516183 |
| 82.81286 | 6795.419122 | 6784.029579 | 26.00593558 | 60.74440066 | −0.16788757 |
| 71.77115 | 5886.333309 | 5879.492302 | 22.38493804 | 52.28651132 | −0.116353692 |
| 55.20857 | 4522.686386 | 4522.686386 | 17.93568621 | 41.893994 | 0 |
| 27.60429 | 2271.465913 | 2261.343193 | 10.35585307 | 24.1890966 | −0.447641887 |

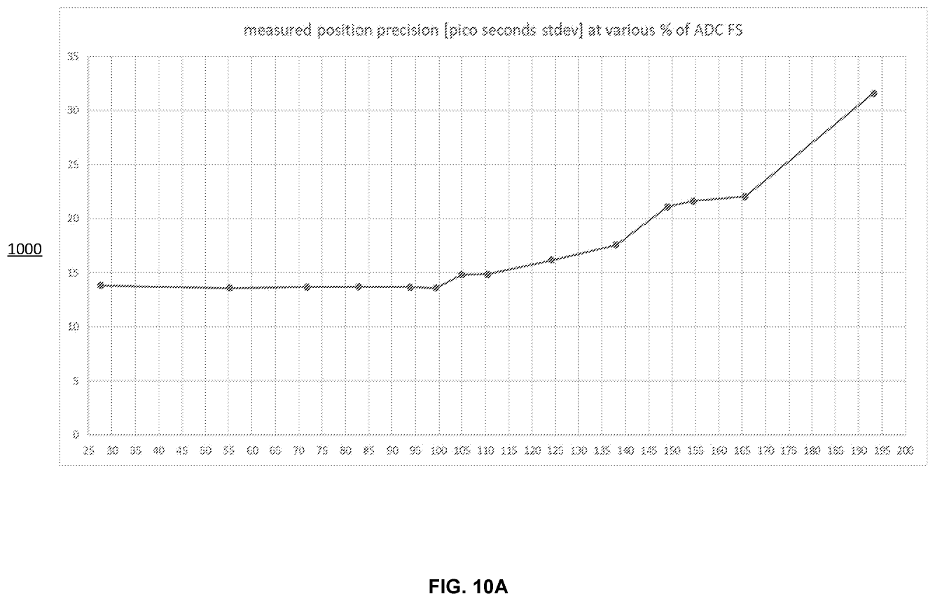

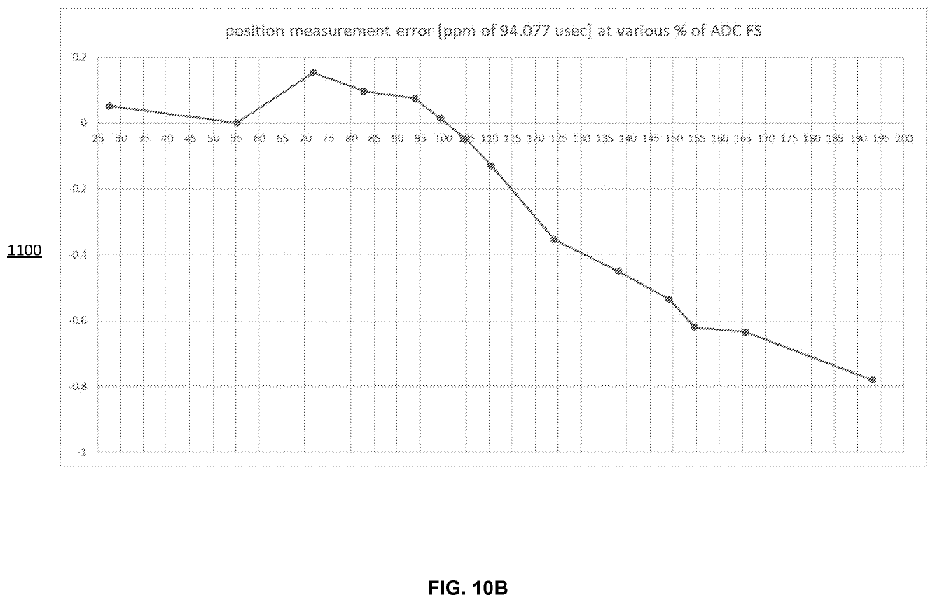

FIG. 10A illustrates a plot of event position measurement precision as function of analog-to-digital convertor (ADC) full scale (FS), in accordance with an example embodiment of the present disclosure. Shown in FIG. 10A is plot 1000, illustrating measured position standard deviation (stdev) (on the y-axis) as function of the percentage of ADC FS (on the x-axis) for an example event saturation correction.

FIG. 10B illustrates a plot of event position measurement accuracy as function of analog-to-digital convertor (ADC) full scale (FS), in accordance with an example embodiment of the present disclosure. Shown in FIG. 10B is plot 1100, illustrating the error in position measurements in parts per million (ppm) of expected position of 94.077 microseconds (on the y-axis) as function of the percentage of ADC FS (on the x-axis) for an example event saturation correction. In this regard, as illustrated in plot 1100, position measured at 55.2% of FS is taken as reference for real position. Table 4, below, includes the data used in generating plots 1000 and 1100:

TABLE 4
Test based data for position measurement precision
and accuracy for events exceeding the ADC FS

| % FS | position | position stdev [psec] | position error [ppm] |
|---|---|---|---|
| 193.23 | 94076863.38 | 31.57017717 | −0.781150872 |
| 165.6257 | 94076877.13 | 22.04639846 | −0.635076946 |
| 154.584 | 94076878.42 | 21.63877895 | −0.621291686 |
| 149.0631 | 94076886.39 | 21.10558149 | −0.536587079 |
| 138.0214 | 94076894.55 | 17.57847949 | −0.449806378 |
| 124.2193 | 94076903.54 | 16.16797348 | −0.354306086 |
| 110.4171 | 94076924.66 | 14.84717378 | −0.129797354 |
| 104.8963 | 94076932.2 | 14.81682559 | −0.049701674 |
| 99.37543 | 94076938.2 | 13.5802909 | 0.014075913 |
| 93.85458 | 94076943.88 | 13.67726764 | 0.07453175 |
| 82.81286 | 94076945.97 | 13.70956574 | 0.096704427 |
| 71.77115 | 94076951.26 | 13.67245743 | 0.152925034 |
| 55.20857 | 94076936.87 | 13.59401911 | 0 |
| 27.60429 | 94076941.71 | 13.83412039 | 0.051404071 |

An example mass spectrometer system, in accordance with the present disclosure, comprises a data acquisition subsystem configured to generate digital data during time-of-flight (TOF) based mass spectrometry and a processing circuit. The data acquisition subsystem comprising an ions detector configured to generate one or more TOF based signals in response to detection of ions during the TOF based mass spectrometry, and an analog-to-digital convertor (ADC) circuit configured to digitize the one or more TOF based signals, to generate corresponding digitized data. The processing circuit configured to process the digitized data, in real-time and based on use of Gaussian fitting, to generate result data corresponding to the TOF based mass spectrometry.

In an example implementation, the processing circuit is further configured to apply, when performing the Gaussian fitting, second (2nd) degree polynomial fit by least squares via QR factorization.

In an example implementation, the processing circuit is further configured to determine, based on the processing of the digitized data, pulse related parameters, and wherein the pulse related parameters comprise a parameter associated with at least one of amplitude, position, and pulse width.

In an example implementation, the processing circuit is further configured to, based on the processing of the digitized data, filter out noise in at least one of the one or more TOF based signals, and wherein the filtering comprises discriminating between noise and real parts of pulse.

In an example implementation, the processing circuit is further configured to increase, based on the processing of the digitized data, linear dynamic range, and wherein the increasing comprises estimation of true signal amplitude, position, and/or width of a saturated peak for at least one of the one or more TOF based signals.

In an example implementation, the processing circuit is further configured to determine, based on the processing of the digitized data, in real-time deconvolution of coalesced peaks for at least one of the one or more TOF based signals.

In an example implementation, the data acquisition subsystem configured to support 4-channel acquisition/analog-to-digital conversion via four (4) independent and in parallel channels.

In an example implementation, the data acquisition subsystem configured to support up to 5G samples/second acquisition/analog-to-digital conversion per channel.

In an example implementation, the data acquisition subsystem configured to apply acquisition/analog-to-digital conversion at approximately 2.5G samples/second per channel.

In an example implementation, the data acquisition subsystem configured to support 14-bit acquisition/analog-to-digital conversion.

An method for mass spectrometry, in accordance with the present disclosure, comprises: applying acquisition/analog-to-digital conversion, wherein the acquisition/analog-to-digital conversion comprises: generating, in response to detection of ions during time-of-flight (TOF) based mass spectrometry, one or more time-of-flight (TOF) based signals; and digitizing, using analog-to-digital conversion, the one or more TOF based signals, to generate corresponding digitized data; and processing the digitized data, in real-time and based on use of Gaussian fitting, to generate result data corresponding to the TOF based mass spectrometry.

In an example implementation, the Gaussian fitting comprises applying second (2nd) degree polynomial fit by least squares via QR factorization.

In an example implementation, the method further comprises determining, based on the processing of the digitized data, pulse related parameters, and pulse related parameters comprise a parameter associated with at least one of amplitude, position, and pulse width.

In an example implementation, the method further comprises filtering out, based on the processing of the digitized data, noise in at least one of the one or more TOF based signals, and wherein the filtering comprises discriminating between noise and real parts of pulse.

In an example implementation, the method further comprises increasing, based on the processing of the digitized data, linear dynamic range corresponding to the one or more TOF based signals, wherein the increasing comprises estimation of true signal amplitude, position, and/or width of a saturated peak for at least one of the one or more TOF based signals.

In an example implementation, the method further comprises determining in real-time, based on the processing of the digitized data, deconvolution of coalesced peaks for at least one of the one or more TOF based signals.

In an example implementation, the method further comprises configuring the acquisition/analog-to-digital conversion as 4-channel acquisition/analog-to-digital conversion.

In an example implementation, the method further comprises applying the acquisition/analog-to-digital conversion up to 5G samples/second.

In an example implementation, the method further comprises applying the acquisition/analog-to-digital conversion at approximately 2.5G samples/second independently per channel.

In an example implementation, the method further comprises configuring the acquisition/analog-to-digital conversion as 14-bit acquisition/analog-to-digital conversion.

Accordingly, various embodiments in accordance with the present invention may be realized in hardware, software, or a combination of hardware and software. The present invention may be realized in a centralized fashion in at least one computing system, or in a distributed fashion where different elements are spread across several interconnected computing systems. Any kind of computing system or other apparatus adapted for carrying out the methods described herein is suited. A typical combination of hardware and software may be a general-purpose computing system with a program or other code that, when being loaded and executed, controls the computing system such that it carries out the methods described herein. Another typical implementation may comprise an application specific integrated circuit or chip.

Various embodiments in accordance with the present invention may also be embedded in a computer program product, which comprises all the features enabling the implementation of the methods described herein, and which when loaded in a computer system is able to carry out these methods. Computer program in the present context means any expression, in any language, code or notation, of a set of instructions intended to cause a system having an information processing capability to perform a particular function either directly or after either or both of the following: a) conversion to another language, code or notation; b) reproduction in a different material form.

While the present invention has been described with reference to certain embodiments, it will be understood by those skilled in the art that various changes may be made and equivalents may be substituted without departing from the scope of the present invention. In addition, many modifications may be made to adapt a particular situation or material to the teachings of the present invention without departing from its scope. Therefore, it is intended that the present invention not be limited to the particular embodiment disclosed, but that the present invention will include all embodiments falling within the scope of the appended claims.

What is claimed is:

1. A mass spectrometer system comprising:
a data acquisition subsystem configured to generate digital data during time-of-flight (TOF) based mass spectrometry, the data acquisition subsystem comprising:
an ions detector configured to generate one or more TOF based signals in response to detection of ions during the TOF based mass spectrometry; and
an analog-to-digital convertor (ADC) circuit configured to digitize the one or more TOF based signals, to generate corresponding digitized data; and
a processing circuit configured to process the digitized data, in real-time and based on use of Gaussian fitting, to generate result data corresponding to the TOF based mass spectrometry.

2. The mass spectrometer system of claim 1, wherein the processing circuit is further configured to apply, when performing the Gaussian fitting, second (2nd) degree polynomial fit by least squares via QR factorization.

3. The mass spectrometer system of claim 1 or claim 2, wherein the processing circuit is further configured to determine, based on the processing of the digitized data, pulse related parameters, and wherein the pulse related parameters comprise a parameter associated with at least one of amplitude, position, and pulse width.

4. The mass spectrometer system of any one of the preceding claims, wherein the processing circuit is further configured to, based on the processing of the digitized data, filter out noise in at least one of the one or more TOF based signals, and wherein the filtering comprises discriminating between noise and real parts of pulse.

5. The mass spectrometer system of any one of the preceding claims, wherein the processing circuit is further configured to increase, based on the processing of the digitized data, linear dynamic range, and wherein the increasing comprises estimation of true signal amplitude, position, and/or width of a saturated peak for at least one of the one or more TOF based signals.

6. The mass spectrometer system of any one of the preceding claims, wherein the processing circuit is further configured to determine, based on the processing of the digitized data, in real-time deconvolution of coalesced peaks for at least one of the one or more TOF based signals.

7. The mass spectrometer system of any one of the preceding claims, wherein the data acquisition subsystem configured to support 4-channel acquisition/analog-to-digital conversion via four (4) independent and in parallel channels.

8. The mass spectrometer system of any one of the preceding claims, wherein the data acquisition subsystem configured to support up to 5G samples/second acquisition/analog-to-digital conversion per channel.

9. The mass spectrometer system of claim 8, wherein the data acquisition subsystem configured to apply acquisition/analog-to-digital conversion at approximately 2.5G samples/second per channel.

10. The mass spectrometer system of any one of the preceding claims, wherein the data acquisition subsystem configured to support 14-bit acquisition/analog-to-digital conversion.

11. A method for mass spectrometry, the method comprising:
applying acquisition/analog-to-digital conversion, wherein the acquisition/analog-to-digital conversion comprises:
generating, in response to detection of ions during time-of-flight (TOF) based mass spectrometry, one or more time-of-flight (TOF) based signals; and
digitizing, using analog-to-digital conversion, the one or more TOF based signals, to generate corresponding digitized data; and
processing the digitized data, in real-time and based on use of Gaussian fitting, to generate result data corresponding to the TOF based mass spectrometry.

12. The method of claim 11, wherein the Gaussian fitting comprises applying second (2nd) degree polynomial fit by least squares via QR factorization.

13. The method of claim 11 or claim 12, further comprising determining, based on the processing of the digitized data, pulse related parameters, and pulse related parameters comprise a parameter associated with at least one of amplitude, position, and pulse width.

14. The method of any one of claims 11 to 13, further comprising filtering out, based on the processing of the digitized data, noise in at least one of the one or more TOF based signals, and wherein the filtering comprises discriminating between noise and real parts of pulse.

15. The method of any one of claims 11 to 14, further comprising increasing, based on the processing of the digitized data, linear dynamic range corresponding to the one or more TOF based signals, wherein the increasing comprises estimation of true signal amplitude, position, and/or width of a saturated peak for at least one of the one or more TOF based signals.

16. The method of any one of claims 11 to 15, further comprising determining in real-time, based on the processing of the digitized data, deconvolution of coalesced peaks for at least one of the one or more TOF based signals.

17. The method of any one of claims 11 to 16, further comprising configuring the acquisition/analog-to-digital conversion as 4-channel acquisition/analog-to-digital conversion.

18. The method of any one of claims 11 to 17, further comprising applying the acquisition/analog-to-digital conversion up to 5G samples/second per channel.

19. The method of claim 18, further comprising applying the acquisition/analog-to-digital conversion at approximately 2.5G samples/second independently per channel.

20. The method of any one of claims 11 to 19, further comprising configuring the acquisition/analog-to-digital conversion as 14-bit acquisition/analog-to-digital conversion.
